(19) United States
(12) Patent Application Publication
(10) Pub. No.: US 2014/0237170 A1
(43) Pub. Date: Aug. 21, 2014

(54) STORAGE DEVICE, AND READ COMMAND EXECUTING METHOD

(71) Applicant: Kabushiki Kaisha Toshiba, Minato-ku (JP)

(72) Inventor: Kazuhito OKITA, Kunitachi-shi (JP)

(73) Assignee: Kabushiki Kaisha Toshiba, Minato-ku (JP)

(21) Appl. No.: 14/264,938

(22) Filed: Apr. 29, 2014

Related U.S. Application Data
(63) Continuation-in-part of application No. 13/606,092, filed on Sep. 7, 2012.

(30) Foreign Application Priority Data
Sep. 13, 2011 (JP) 2011-199795

(51) Int. Cl. G06F 12/02

(52) U.S. Cl. CPC G06F 12/0246
USPC 711/103

(57) ABSTRACT

A storage device of the embodiment includes memory, a control section, a table holding section for managing a table for holding an identifier, a logical address, and a data length based on a read command, an issuing section for issuing the logical address and the data length for each identifier to the control section, a buffer for holding data received from the memory along with the identifier, and an identifier queue for receiving the identifier of a number proportional to a data length when the data of the logical address of the same identifier is received in the buffer. The storage device of the embodiment includes a transfer section for transferring the data corresponding to the identifier received in the buffer to outside when the identifier is held as incomplete readout in the table in order from the identifier at a head of the identifier queue.

### CROSS-REFERENCE TO RELATED APPLICATIONS

This application is a continuation-in-part of U.S. patent application Ser. No. 13/606,092, with a filing data of Sep. 7, 2012. Priority of the above-mentioned application is claimed and the above-mentioned application is hereby incorporated by reference in its entirely. This application is based upon and claims the benefit of priority from Japanese Patent Application No. 2011-199795, filed on Sep. 13, 2011; the entire contents of which are incorporated herein by reference.

### FIELD

Embodiments of the present invention described herein relate to a storage device, and a read command executing method.

### BACKGROUND

With increase in speed of an initiator (host) that issues a read command targeting on a SSD (Solid State Drive) including NAND flash memory, and the like, memory having a fast data transfer speed is sometimes used for a read buffer. SRAM is suited for such memory, but the SRAM has a small storage capacity compared to DRAM. Thus, enhancement in the transfer efficiency of the readout data from the storage device such as the SSD including the read buffer having a small storage capacity is desired.

However, in a conventional read command processing technique of when a scale of the read buffer is large, the readout data is randomly stored in the read buffer when a plurality of read commands received from the initiator is executed, and thus the transfer to the initiator cannot be started until the readout data with respect to each read command are all obtained in the read buffer. Therefore, firmware (F/W) needs to constantly monitor the transfer status between the NAND flash memory and the read buffer, which occupies the MPU and affects other processes and hence the transfer efficiency cannot be enhanced.

### BRIEF DESCRIPTION OF THE DRAWINGS

FIG. 1 is a block diagram illustrating a configuration of a storage device according to a first embodiment;

FIG. 2 is a function block diagram schematically illustrating an operation relationship among the function blocks according to the first embodiment;

FIG. 3 is a view illustrating a detailed configuration of a reservation exchange table holding section, a read buffer command issuing section, and an exchange executing section according to the first embodiment;

FIG. 4 is a flowchart describing a flow of a process of a read command received from an initiator according to the first embodiment;

FIG. 5 is a flowchart describing a flow of a data transfer process on an NAND side according to the first embodiment;

FIG. 6 is a flowchart describing a flow of a command execution process on an initiator side according to the first embodiment;

FIG. 7 is a timing chart illustrating a state of the read data transfer according to the first embodiment;

FIG. 8 is a block diagram illustrating a configuration of a storage device according to a second embodiment;

FIG. 9 is a block diagram illustrating a configuration of a storage device according to a third embodiment;

FIG. 10 is a function block diagram schematically illustrating an operation relationship among the function blocks according to the third embodiment;

FIG. 11 is a view illustrating a relationship of a transfer management section, a reservation exchange table, and a NAND command issuing section according to the third embodiment;

FIG. 12 is a flowchart illustrating an operation of the storage device according to the third embodiment; and

FIG. 13 is another flowchart illustrating an operation of the storage device according to the third embodiment.

### DETAILED DESCRIPTION

A storage device of the embodiment includes non-volatile memory; a memory control section; a table holding section for managing a table holding an identifier, with which a read command is identifiable, a logical address of readout data corresponding to the identifier, and readout data length corresponding to the identifier based on the read command; a read issuing section for issuing the logical address and the data length for each identifier to the memory control section; a read buffer for holding data received from the non-volatile memory based on a physical address corresponding to the logical address and the data length for each identifier instructed from the memory control section along with the identifier; and an identifier queue for receiving the identifier of a number proportional to a data length of the data when the data of the logical address is received for the same identifier in the read buffer. The storage device of the embodiment further includes a transfer section for transferring the data corresponding to the identifier received in the read buffer to outside when the identifier is held as incomplete readout in the table in order from the identifier at a head of the identifier queue.

### First Embodiment

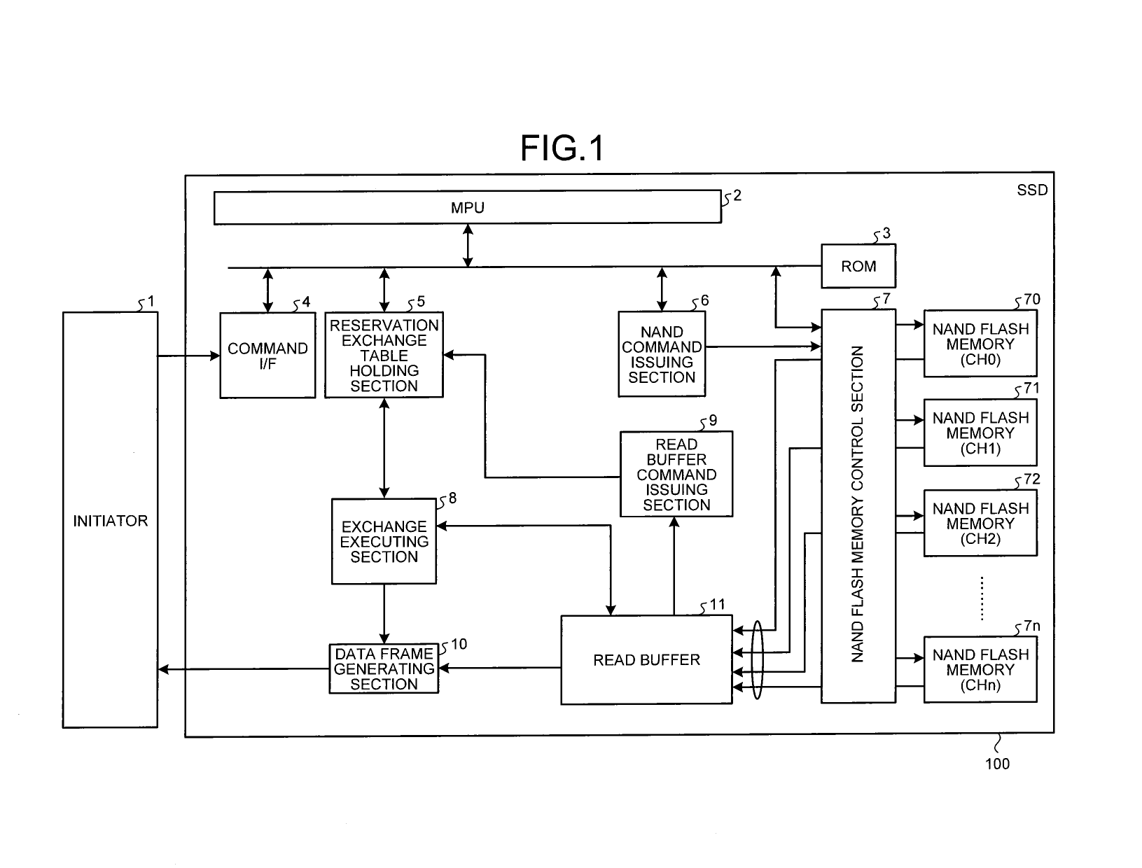

FIG. 1 is a block diagram illustrating a configuration of a storage device 100 according to a first embodiment. The storage device 100 is, for example, an SSD. An initiator 1 is connected to the storage device 100. The initiator 1 is a device adapted to issue a command to a device connected by the SCSI standard, for example. The initiator 1 corresponds to a host in the SATA (Serial Advanced Technology Attachment) standard. The initiator 1 has a role of issuing a command such as readout of data with respect to the connected storage device (target) such as the SSD.

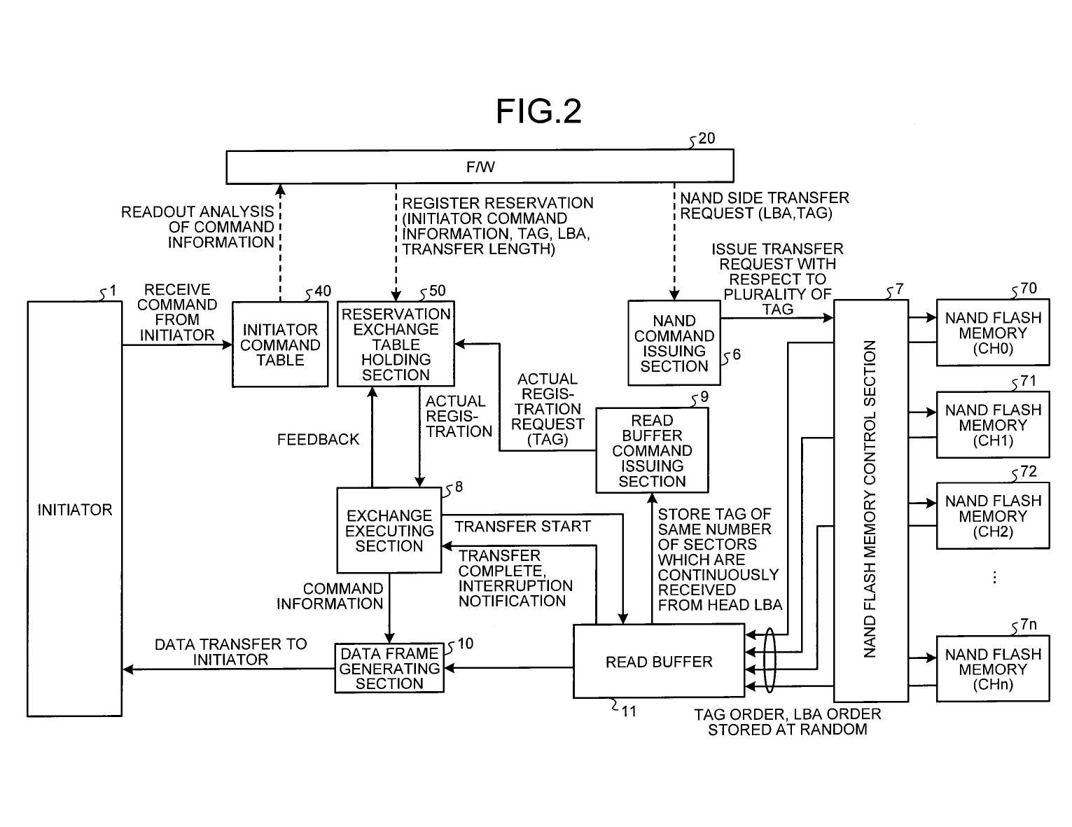

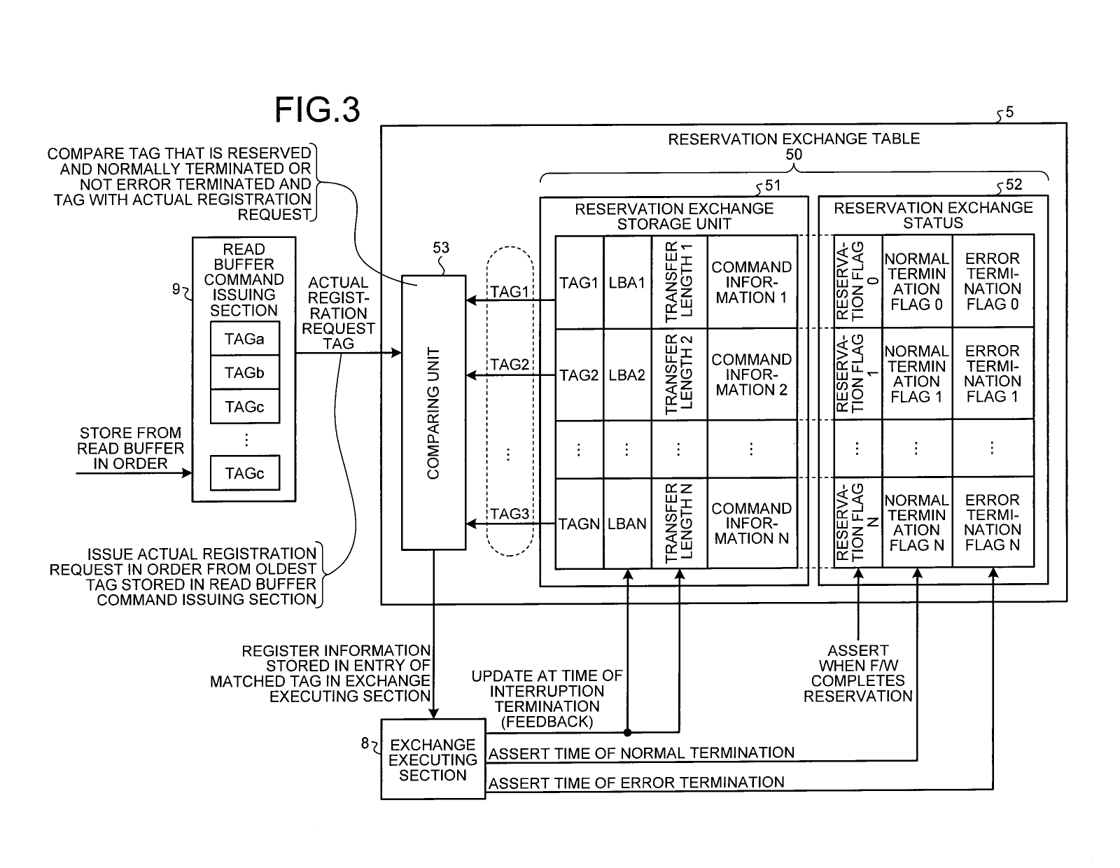

The storage device 100 includes an MPU 2, ROM 3 including EEPROM, a command I/F (interface) 4 adapted to accept the command from the initiator 1, a reservation exchange table holding section 5 to be described later, an exchange executing section 8 adapted to execute the transfer control of the readout data to the initiator 1 and rewrite of a reservation exchange table 50 (FIG. 2, FIG. 3) held by the reservation exchange table holding section 5, a data frame generating section 10 adapted to carry out the transfer of the readout data to the initiator 1, a NAND command issuing section (read issuing section) 6, a NAND flash memory control section (memory control section) 7, NAND flash memories (non-volatile memories) 70, 71, . . . , 7n in which pluralities are mounted in parallel, a read buffer command issuing section (identifier queue) 9, and a read buffer 11. The transfer of the readout data from the NAND flash memories 70, 71, . . . , 7n to the initiator 1 can be efficiently carried out by arranging the read buffer 11.

A firmware (F/W) 20 (see FIG. 2) held by the ROM 3 and executed by the MPU 2 sets the reservation exchange table holding section 5 and the NAND command issuing section 6 based on command information from the command I/F 4. To describe the operation of the storage device 100 of the present embodiment based on the operation of the firmware 20, a function block diagram schematically illustrating an operation relationship among the function blocks including the firmware 20 is illustrated in FIG. 2. A detailed configuration of the reservation exchange table holding section 5, the read buffer command issuing section 9, and the exchange executing section 8 illustrated in FIG. 2 is illustrated in FIG. 3.

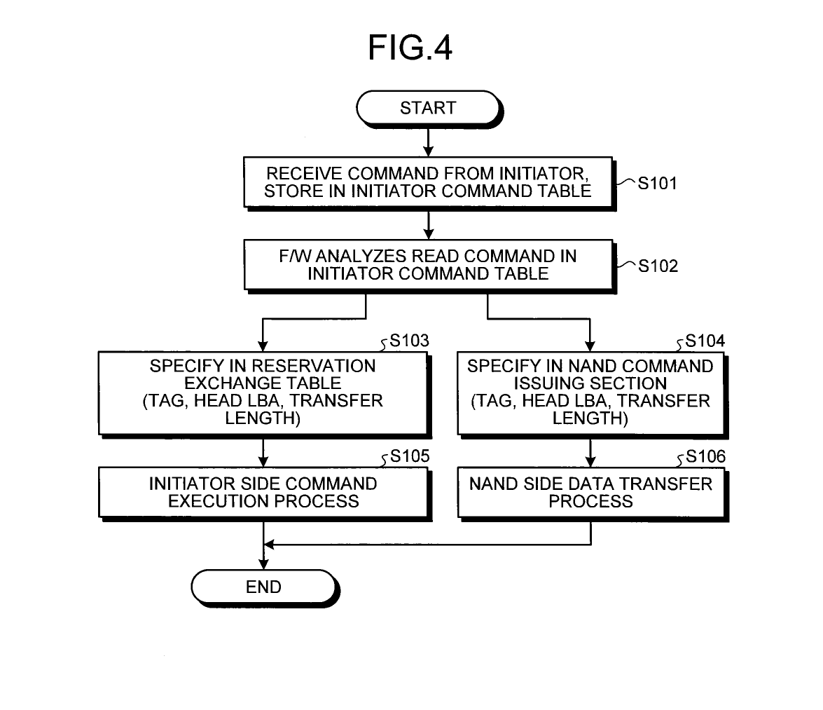

A flow of a process of a read command received from the initiator 1 in the storage device 100 will be described below using flowcharts illustrated in FIG. 1, FIG. 2, and FIG. 4 to FIG. 6.

The read command issued from the initiator 1 to the storage device 100 is received by the command I/F 4, and once stored in an initiator command table 40 managed by the command I/F 4 (FIG. 4: step S101). The firmware 20 analyzes the read command stored in the initiator command table 40 (step S102). The read command includes a logical address of a head of the readout data, and a data length (transfer length) in units of sectors from such logical address. The logical address is an address used by the initiator 1 (host), and is, for example an LBA (Logical Block Addressing), where a serial number starting from 0 is given to the sectors (size: e.g., 512 B). The logical address of the head of the readout data is hereinafter referred to as “head LBA”.

The firmware 20 gives a TAG (tag), which is an identifier that differs at least among the read commands simultaneously entered to the reservation exchange table 50, with respect to the read command received from the initiator 1 through the command I/F 4. In other words, the tag is uniquely determined with respect to the read command from the initiator 1. The firmware 20 grasps (analyzes) the TAG, the head LBA, the transfer length, and the command information with respect to each read command. The command information is, for example, a SAS (Serial Attached SCSI) address for identifying (command from) which initiator. If a plurality of initiators is connected to the storage device 100 through an expander (hub), from which initiator the command is issued can be identified by the SAS address.

The firmware 20 enters the read command to the reservation exchange table 50 of the reservation exchange table holding section 5 based on the above analysis result. Specifically, the TAG, the head LBA, the transfer length, and the command information of each read command to be executed on the reservation exchange table 50 are respectively stored for each TAG (step S103). The reservation exchange table 50 is responsible for a read command process in a function block on a side (hereinafter referred to as initiator side) close to the initiator 1 in the storage device 100. As illustrated in FIG. 3, the reservation exchange table 50 includes a reservation exchange storing unit 51 and a reservation exchange status 52. The reservation exchange storing unit 51 manages each TAG and (non-transferred) head LBA, (non) transfer length, and command information for each TAG. The reservation exchange status 52 manages a reservation flag, a normal termination flag, and an error termination flag for each TAG with respect to each TAG managed by the reservation exchange storing unit 51. At a time point the read command is entered to the reservation exchange table 50, the TAG, the head LBA, the transfer length, and the command information are written to the reservation exchange storing unit 51 by the firmware 20, and the reservation flag of the reservation exchange status 52 with respect to the TAG is asserted. At this time point, both the normal terminal flag and the error termination flag with respect to the relevant TAG are not asserted.

In parallel to the above, the firmware 20 also transmits the read command same as above to the NAND command issuing section 6. Specifically, the TAG, the head LBA, and the transfer length of each read command are stored (step S104). The NAND command issuing section 6 is responsible for the readout data transfer process on the side (hereinafter referred to as NAND side) of the NAND flash memory control section 7 and the NAND flash memories 70, 71, . . . , 7n.

Step S103 and step S104 are executed on all the read commands in the initiator command table 40. The firmware 20 is not involved in the subsequent operations. A command execution process (step S105) on the initiator side is executed after step S103, and a data transfer process (step S106) on the NAND side is executed after step S104. The command execution process (step S105) on the initiator side and the data transfer process (step S106) on the NAND side are processes respectively performed in hardware.

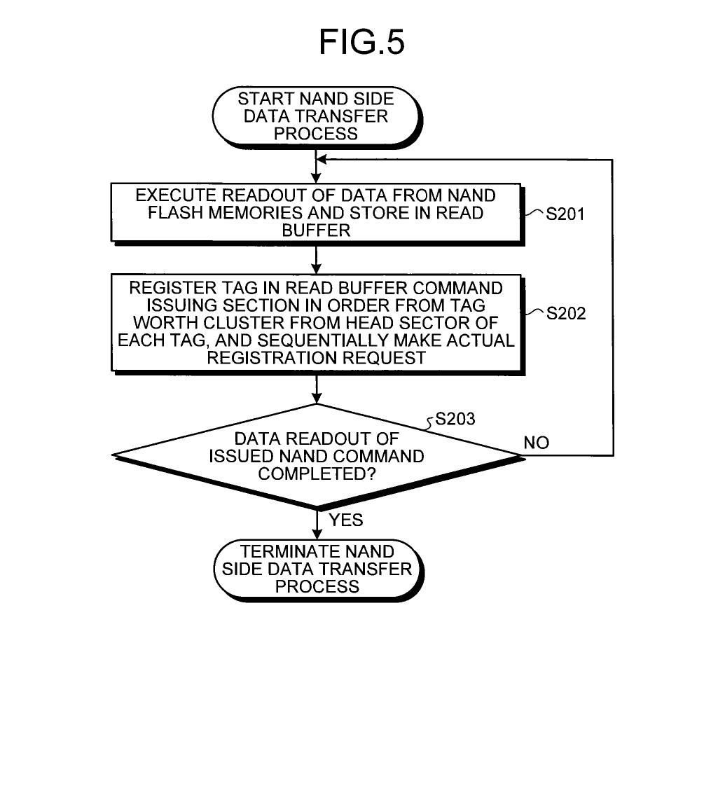

The flow of the data transfer process on the NAND side will be described based on the flowchart of FIG. 5. The NAND command issuing section 6 makes a transfer request on a stored plurality of TAGs to the NAND flash memory control section 7. In the NAND flash memory control section 7, the head LBA stored in the NAND command issuing section 6 is converted to a physical address in the NAND flash memories 70, 71, . . . , 7n, and sequentially issued from the NAND flash memory control section 7 to the NAND flash memories 70, 71, . . . , 7n as the NAND command (read command) along with the transfer length. The NAND flash memories 70, 71, . . . , 7n store the specified readout data in the read buffer 11 (step S201). In this case, the readout data stored in the read buffer 11 is asynchronously stored irrespective of the issued order of the read command, and the order of the LBA. This is because the sequential property (continuity) of the data gets lost as the write is carried out in parallel with respect to each channel of the NAND flash memories 70, 71, . . . , 7n when writing the data. It is also caused by an individual difference in the read access time of the NAND flash memories 70, 71, . . . , 7n.

The read buffer 11 grasps in units of sectors to what extent the readout data is received from the NAND flash memories 70, 71, . . . , 7n from the head LBA for each TAG. The management information such as the data length (number of sectors) for each TAG necessary therefor are provided beforehand from the firmware 20.

When receiving, from the NAND flash memories 70, 71, . . . , 7n, the data of the number of sectors continued in terms of the LBA starting from the head LBA for a certain TAG, the read buffer 11 sequentially stores the TAG of the number of sectors in the read buffer command issuing section 9. For instance, when receiving from the NAND flash memories 70, . . . , 7n, the data of the number of sectors (four sectors) of LBA=0 to 3 when the readout of the TAG=“A” is LBA=0 to 15 as a whole, and then receiving from the NAND flash memories 70, . . . , 7n, the readout data of TAG=“B”, the four TAG “A” are first sequentially stored in the read buffer command issuing section 9, and then, the TAG=“B” is stored in the read buffer command issuing section 9 by the number of continuously received sectors. Thereafter, if the readout data after LBA=4 of the TAG=“A” are continuously received from the NAND 70, . . . , 7n, the TAG=“A” is stored in the read buffer command issuing section 9 by the number of continuously received sectors. If the data of the head LBA of the TAG=“A” is received for one sector, then the data of the head LBA of the TAG=″B″ is received for one sector, and then the data of the LBA after one sector from the head LBA of the TAG=“A” (data continuing to the data of TAG=“A” received first) is received for one sector, the TAG is stored in the order of TAG=“A”, “B”, “A” in the read buffer command issuing section 9.

Generally, when reception of the data continued from the head LBA for a certain TAG is completed for one cluster (e.g., eight sectors), which is a minimum unit of the readout data from the NAND flash memories 70, 71, . . . , 7n, the read buffer 11 sequentially stores the TAG same as the number (e.g., eight) of sectors of the received one cluster in the read buffer command issuing section 9. For instance, if the readout data of TAG=“A” is stored for eight sectors continuously in terms of LBA in the read buffer 11, eight TAGs of “A” are sequentially stored in the read buffer command issuing section 9.

The read buffer 11 sequentially stores the TAG of the number corresponding to the number of sectors of the continuously received data in the read buffer command issuing section 9 every time the data of the number of sectors continued in terms of LBA from the head LBA of a certain TAG is received from the NAND flash memories 70, 71, . . . , 7n. If the reception from the NAND of the readout data continued in the order of LBA is interrupted for the relevant TAG, the relevant TAG is not stored in the read buffer command issuing section 9 until the readout data of the head LBA of the non-transferred readout data of the TAG is received from the NAND. Therefore, the readout data in the order of LBA among the same TAG are read transferred to the initiator 1 while maintaining the order of LBA according to a mechanism described later.

The read buffer command issuing section 9 is a FIFO type buffer (tag queue), as illustrated in FIG. 3, where the actual registration request is made to the reservation exchange holding section 5 for each TAG in order from the TAG stored first (step S202). In other words, the actual registration request (read buffer command) is requested in units of sectors. When the data readout from the NAND flash memories 70, 71, . . . , 7n with respect to all the NAND commands issued from the NAND flash memory control section 7 is completed (step S203: Yes), the data transfer process on the NAND side is terminated, and hence step S106 of FIG. 4 is terminated. If the data readout from the NAND flash memories 70, 71, . . . , 7n is not completed in step S203 (step S203: No), the process returns to step S201. The data transfer operation on the NAND side is as described above.

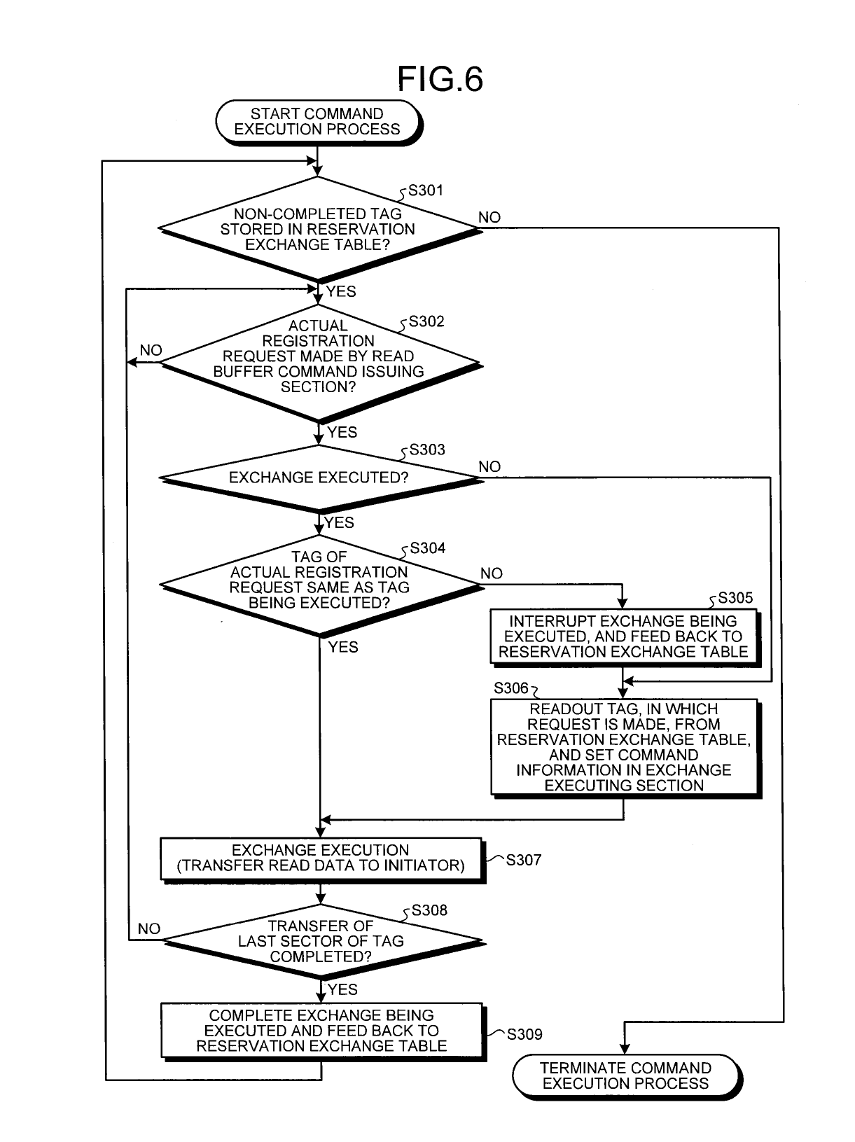

The flow of the command execution process on the initiator side will now be described based on the flowchart of FIG. 6. First, whether or not a TAG (non-completed TAG) in which the reservation flag is asserted and the normal termination flag and the error termination flag are not asserted exists in the reservation exchange status 52 of the reservation exchange table holding section 5 is determined (FIG. 6, step S301). If it does not exist (step S301: No), the command execution process is terminated. If it exists (step S301: Yes), the arrival of the actual registration request (FIG. 5, step S202) by the read buffer command issuing section 9 is waited (step S302: No). If the actual registration request is made by the read buffer command issuing section 9 to the reservation exchange table holding section 5 (step S302: Yes), whether or not the exchange executing section 8 is already operating (in exchange execution) is determined (step S303).

If the exchange executing section 8 is not operating (step S303: No), a comparing unit 53 searches for the TAG, in which the actual registration request is made, from the reservation exchange table 50. Specifically, the comparing unit 53 searches for that in which the TAG, in which the actual registration request is made, is entered in the reservation exchange storing unit 51 and the normal termination flag and the error termination flag of the reservation exchange status 52 of the TAG are both not asserted. The comparing unit 53 sets the command information of the searched TAG in the exchange executing section 8 (step S306). The exchange executing section 8 transfers the readout data of the TAG from the read buffer 11 to the data frame generating section 10, and transmits the set command information to the data frame generating section 10. The data frame generating section 10 creates the data frame based on the readout data transmitted from the read buffer 11 and the command information from the exchange executing section 8, and transfers the same to the initiator 1 (read data transfer) (exchange execution: step S307).

If the exchange executing section 8 is operating (step S303: Yes), the comparing unit 53 determines whether or not the TAG in which the actual registration request is made is the same as the TAG being exchange executed (step S304). If the TAGs are the same (step S304: Yes), the read data transfer of the same TAG is continuously carried out based on the command information being executed (step S307). If the TAG of the actual registration request is different from the TAG being exchange executed (step S304: No), the head LBA and the transfer length in the reservation exchange storing unit 51 of the TAG being exchange executed are updated. Specifically, “head LBA” is rewritten to the LBA at the head of the non-transferred sector excluding the sectors transferred up to now, and “transfer length” is rewritten to the number of non-transferred sectors. In other words, the rewrite (feedback) of the reservation exchange table 50 is carried out with the interruption of the exchange with respect to the TAG being executed (step S305). After step S305, the comparing unit 53 searches for the command information of the TAG of the actual registration request from the reservation exchange storing unit 51 and sets the same in the exchange executing section (step S306). The readout data of the TAG is transferred to the initiator 1 as the data frame (step S307).

Whether or not the transfer of the final sector of the readout data of the TAG is completed is determined every time the readout data of each TAG is transferred to the initiator 1 in units of sectors in step S307 (step S308), where the arrival of the next actual registration request is waited (step S302) if not completed (step S308: No). If the transfer of the final sector of the TAG in which the readout data is transferred to the initiator 1 is completed in step S308, that is, when the transfer length of the non-transferred sector of the TAG becomes 0 (step S308: Yes), the exchange being executed is completed and fed back to the reservation exchange table 50 (step S309). Specifically, the normal termination flag of the TAG of the reservation exchange status 52 is asserted. Alternatively, the entry of the TAG may be deleted from the reservation exchange table 50. If an error occurs in one of the process of the above procedure, for instance, if the data readout from the NAND flash memories 70, 71, . . . , 7n fails or if the initiator 1 and the storage device 100 are disconnected, the error termination flag of the reservation exchange status 52 of the TAG is asserted.

In the conventional read command processing technique, when a plurality of read commands identified by the TAG=“A”, “B”, “C” received from the initiator 1 in FIG. 2 is executed, for instance, if the readout data is randomly stored in the read buffer 11 from the two channels of the NAND flash memory 70 (CH0) and the NAND flash memory 71 (CH1), the transfer to the initiator 1 cannot be started until all the readout data with respect to each read command (each TAG) are obtained in the read buffer 11. In other words, the transfer to the initiator 1 cannot be started until the last readout data of each TAG is obtained in the read buffer 11.

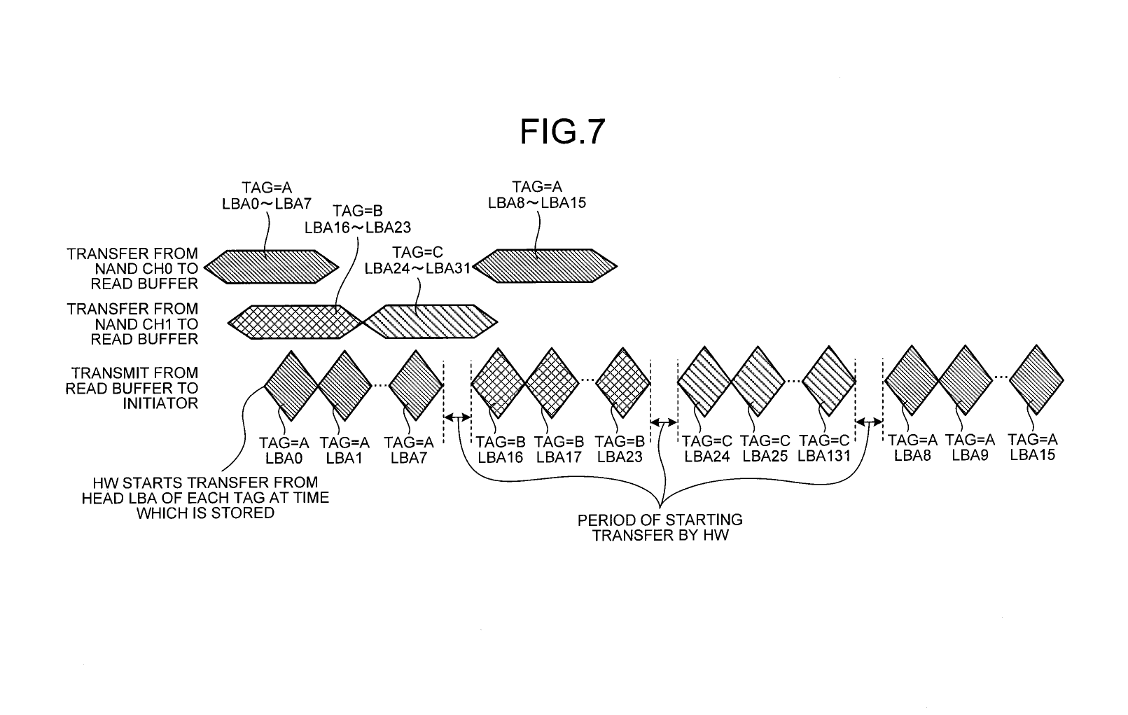

According to the read command executing method of the storage device 100 of the present embodiment, on the other hand, the read data transfer to the initiator 1 is enabled, as illustrated in the timing chart of FIG. 7. In other words, when the data transfer of three types of TAG from the two channels of the NAND flash memory 70 (CH0) and the NAND flash memory 71 (CH1) is performed, the transmission from the read buffer 11 to the initiator 1 can be carried out at the time point the readout data from the head LBA of the TAG=“A” are obtained in the read buffer 11. Thus, the read buffer 11 does not need to buffer until all the readout data with respect to each read command are obtained, and hence efficient transfer of the readout data can be enabled in the small scale read buffer 11. In other words, according to the read command executing method of the storage device 100 of the present embodiment, the firmware 20 first sets the reservation exchange table 50 and the NAND command issuing section 6 based on the read command, so that thereafter, the efficient transfer of the readout data from the read buffer 11 to the initiator 1 can be executed with only the operation of the hardware. In other words, after the setting to the reservation exchange table 50 and the NAND command issuing section 6, the efficient read data transfer can be enabled without the firmware 20 monitoring the transfer status between the NAND flash memories 70, 71, . . . , 7n and the read buffer 11.

### Second Embodiment

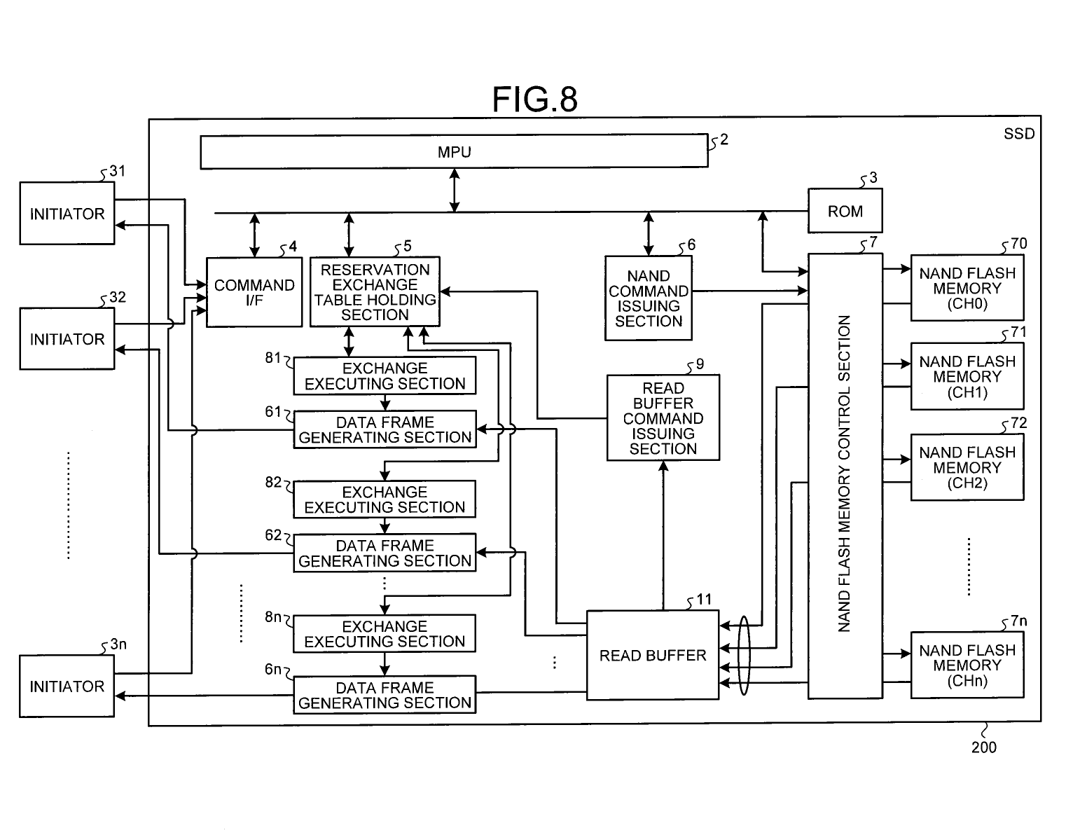

FIG. 8 is a block diagram illustrating a configuration of a storage device 200 according to a second embodiment. The storage device 200 includes a plurality of ports, so that a plurality of initiators 31, 32, . . . , 3n can be connected to the plurality of ports. The storage device 200 of the present embodiment enables an efficient execution of the read command from each of the plurality of initiators 31, 32, . . . , 3n, similar to the first embodiment. The configuration of the storage device 200 includes exchange executing sections 81, 82, . . . , 8n and data frame generating sections 61, 62, . . . , 6n respectively corresponding to each initiator 31, 32, . . . , 3n, but other configurations are similar to the storage device 100 of FIG. 1.

In the present embodiment, efficient read data transfer can be carried out, similar to the first embodiment, since from which initiator 31, 32, . . . , 3n the read command is from can be identified by the SAS address, which is the command information of the reservation exchange storing unit 51 of the reservation exchange table 50. In other words, the transfer distribution of the readout data corresponding to the read command to the respective port (initiator) can be enabled.

However, for example, if one of the ports and the initiators are disconnected, the reservation exchange table holding section 5 temporarily stops the reception of the actual registration request based on the command information (SAS address) corresponding to the actual registration request (TAG) with respect to the actual registration request (read buffer command) from the read buffer command issuing section 9 corresponding to the read command from the initiator connected to the port, so that the processing of the read command from the initiator other than the relevant port can be executed without any problems.

As described above, according to the first and second embodiments, the efficient transfer of the readout data can be enabled in the small scale read buffer without the firmware monitoring the transfer status between the NAND flash memory and the read buffer.

### Third Embodiment

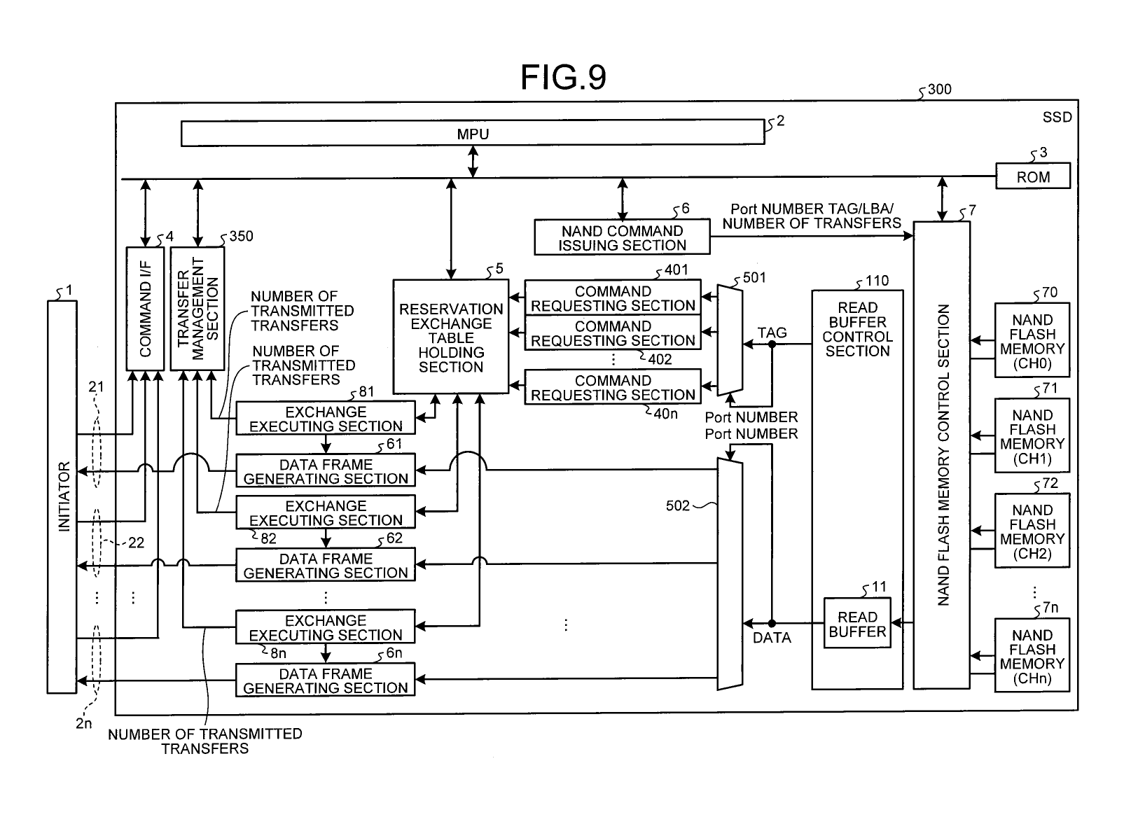

FIG. 9 is a block diagram illustrating a configuration of a storage device 300 according to a third embodiment. The storage device 300 is, for example, an SSD. The initiator 1 is connected to the storage device 300. The storage device 300 has N communication ports 21 to 2n to connect with the initiator 1, and enables a Wide Port connection in which the communication ports are connected to one initiator 1.

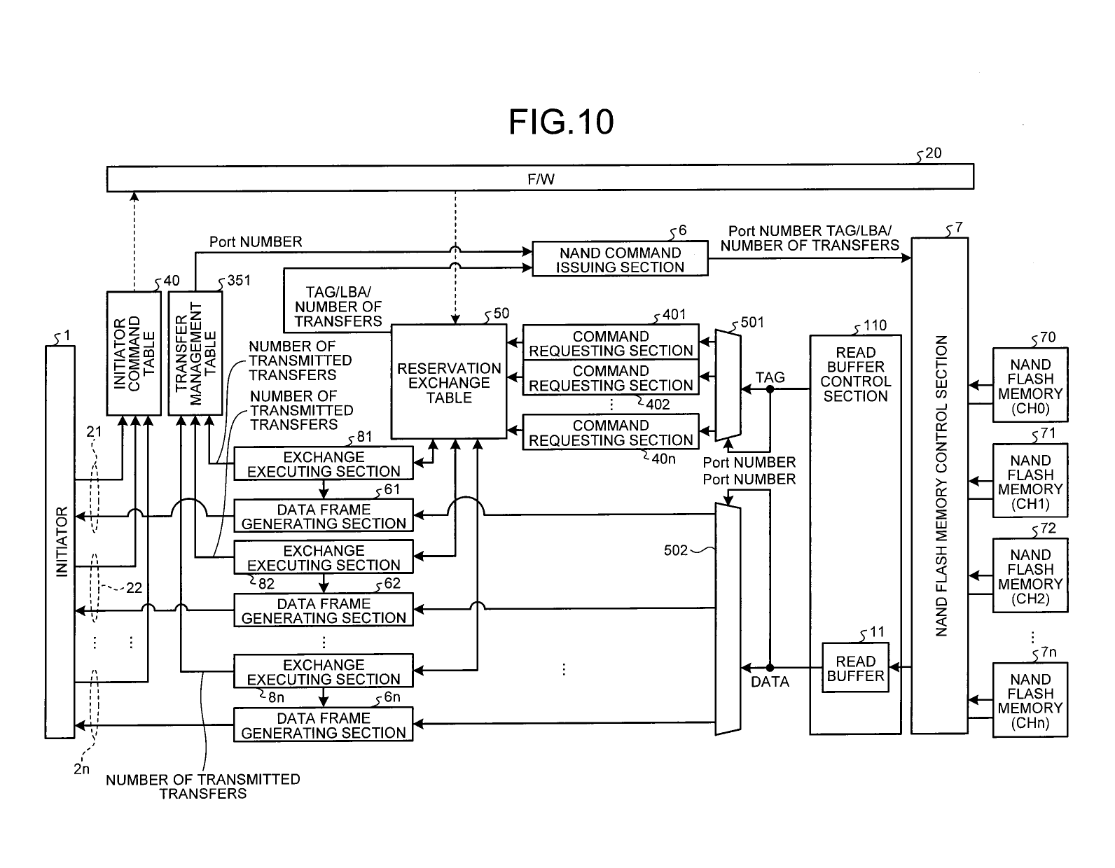

The storage device 300 includes the MPU 2, the ROM 3 including EEPROM, the command I/F (interface) 4 adapted to accept the command from the initiator 1, the reservation exchange table holding section 5 adapted to hold the reservation exchange table 50 (FIG. 10), the exchange executing sections 81 to 81n adapted to execute the transfer control of the readout data to the initiator 1 and rewrite of the reservation exchange table 50, the data frame generating sections 61 to 61n adapted to carry out the transfer of the readout data to the initiator 1, the NAND command issuing section (read issuing section) 6, the NAND flash memory control section 7, the NAND flash memories 70 to 70n in which pluralities are mounted in parallel, a transfer management section 350, the read buffer 11, and a read buffer control section 110 adapted to control the read buffer 11.

To describe the operation of the storage device 300 of the present embodiment based on the operation of the firmware 20 (F/W) held by the ROM 3 and executed by the MPU 2, a function block diagram including the firmware 20 is illustrated in FIG. 10. The command I/F 4 manages the initiator command table 40. The transfer management section 350 manages a transfer management table 351.

The command received by the storage device 300 from the initiator 1 is allocated to the respective communication ports 21 to 2n to carry out the data transfer. The NAND flash memories 70 to 7n are connected to the NAND flash memory control section 7 in pluralities and in parallel. The storage device 300 includes the read buffer 11 adapted to temporarily store data between the initiator 1 and the NAND flash memories 70 to 7n.

The NAND flash memory control section 7 sequentially reads out the data from the NAND flash memories 70 to 7n based on Port number, TAG, LBA, and number of transfers notified from the NAND command issuing section 6, and stores the same in the read buffer 11. The read buffer control section 110 manages the storage situation to the read buffer 11 for every TAG. The read buffer control section 110 notifies the TAG and the Port number corresponding thereto to command requesting sections 401 to 40n at the time point the storage of data to the read buffer 11 is completed. The command requesting sections 401 to 40n cause the transmission of information necessary for generating the data frame from the reservation exchange table 50 to the exchange executing sections 81 to 8n. On the basis of such information, the exchange executing sections 81 to 8n cause the initiator 1 to sequentially transfer the data received from the read buffer 11 to the data frame generating sections 61 to 6n. The transfer of data from the read buffer 11 to the data frame generating sections 61 to 6n corresponding to the communication ports 21 to 2n is sequentially carried out while being switched by a selector 502 according to the Port number added to the data.

In the present embodiment, the transfer management section 350 determines the Port number to notify from the NAND command issuing section 6 to the NAND flash memory control section 7 based on the transfer situation to each Port, which is managed by the transfer management section 350, in the storage device 300 having the above configuration. The ports that transmit the data to the initiator 1 thus can be allocated, and the transfer efficiency can be enhanced.

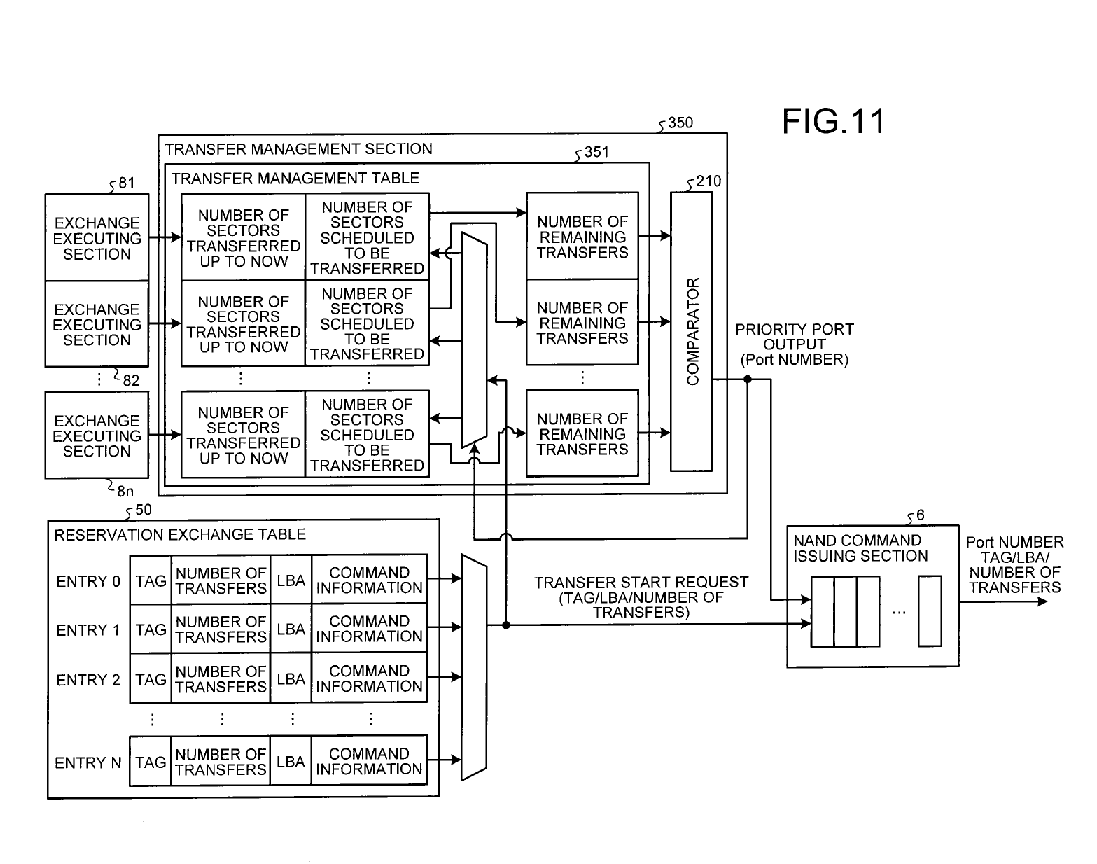

FIG. 11 is a view illustrating a relationship of the transfer management section 350, the reservation exchange table 50, and the NAND command issuing section 6. The reservation exchange table 50 stores TAG; LBA, which is the logical address of the head of the readout data; number of transfers, which is the data length (transfer length) in units of sectors from the LBA; and command information as each entry. The transfer management section 350 includes the transfer management table 351, and stores the number of sectors transferred up to now and the number of sectors scheduled to be transferred for every Port. The number of remaining transfers is calculated from the difference between the number of sectors scheduled to be transferred and the number of sectors transferred up to now, where a comparator 210 determines the Port having the least number of remaining transfers and determines such Port as the priority Port. The entries are registered in the reservation exchange table 50 based on a read command received by the firmware 20 from the initiator 1 through the command I/F 4. At the time point the entries are registered, the number of sectors scheduled to be transferred corresponding to the priority Port of the transfer management table 351 is added by the registered number of remaining transfers. The priority Port indicated by the transfer management section 350 and the information on the entries including the TAG, the number of transfers, and the LBA registered in the reservation exchange table 50 are sequentially notified to the NAND flash memory control section 7 through the NAND command issuing section 6.

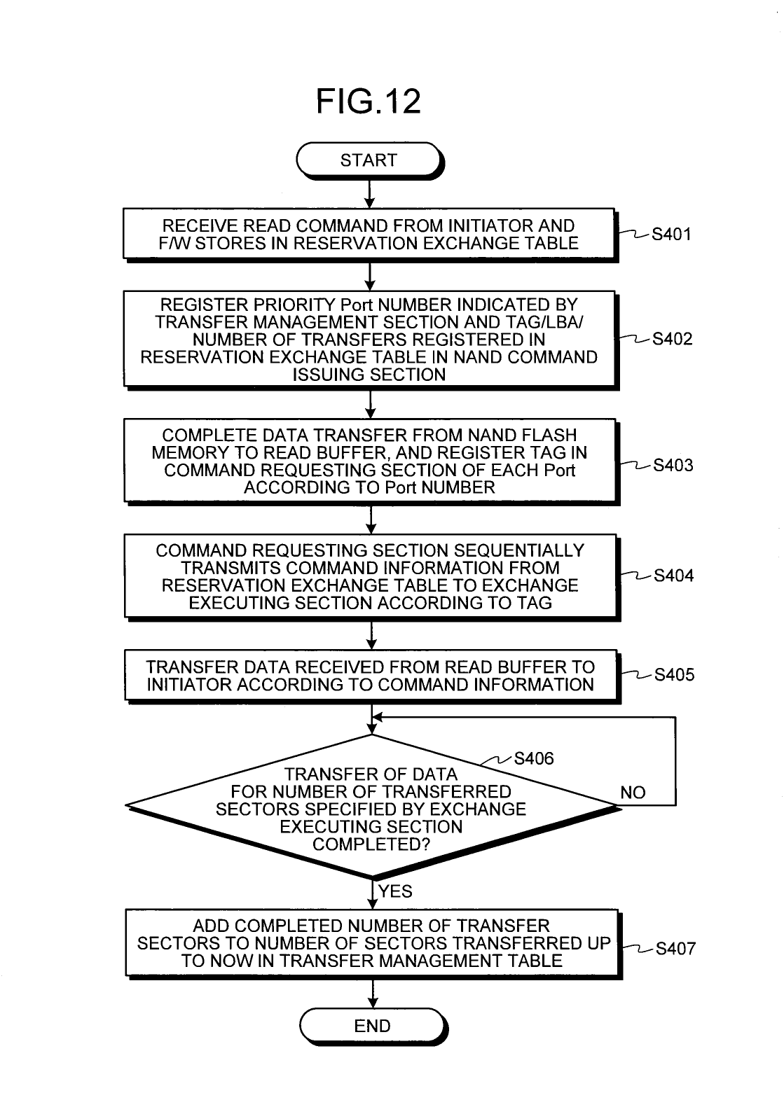

FIG. 12 illustrates a flowchart illustrating the operation of the storage device 300 from the reception of the read command from the initiator 1 to the data transfer to the initiator 1. The read command issued from the initiator 1 to the storage device 300 is received by the command I/F 4, and stored in the initiator command table 40 managed by the command I/F 4. When the read command is stored in the initiator command table 40, the firmware 20 registers the TAG, the LBA, the number of transfers, and the command information in the reservation exchange table 50 as entries (step S401). Furthermore, the TAG, the LBA, and the number of transfers registered in the reservation exchange table 50 are registered in the NAND command issuing section 6 (step S402). At this time, the priority Port number indicated by the transfer management section 350 as illustrated in FIG. 11 is also registered in the NAND command issuing section 6 along with the TAG, the LBA, and the number of transfers. The Port number, the TAG, the LBA, and the number of transfers registered in the NAND command issuing section 6 are notified to the NAND flash memory control section 7. The NAND flash memory control section 7 sequentially executes the readout of the data from the NAND flash memories 70 to 7n to the read buffer 11 according to the information notified from the NAND command issuing section 6. The NAND flash memory control section 7 notifies the Port number and the TAG of the data read out to the read buffer 11 to the read buffer control section 110. After the data transfer from the NAND flash memories 70 to 7n to the read buffer 11 is completed, the TAG and the Port number, which data transfers are completed, are transmitted from the read buffer control section 110 to the selector 501. The selector 501 registers the TAG transmitted from the read buffer control section 110 in one of the command requesting sections 401 to 40n corresponding to the Port number notified from the read buffer control section 110 (step S403). The command requesting sections 401 to 40n sequentially transmit the command information from the reservation exchange table 50 to the exchange executing sections 81 to 8n according to the registered TAG (step S404). The exchange executing sections 81 to 8n cause the data frame generating sections 61 to 6n to read out the data from the read buffer 11 and sequentially carry out data transfer to the initiator 1 according to the command information registered in the reservation exchange table 50 (step S405). In step S405, the selector 502 allocates the readout data to the data frame generating section 61 to 6n corresponding to the relevant Port number to transfer to the initiator 1 since the Port number is added to the readout data of the read buffer 11 or the Port number is notified from the read buffer control section 110.

The exchange executing sections 81 to 8n are notified by the reservation exchange table holding section 5 of the number of transfers of the entry corresponding to the registered TAG, and thereafter, whether or not the exchange executing sections 81 to 8n transferred the data for the sector of a provided number of transfers to the initiator 1 is determined in step S406. If the data for the sector of the provided number of transfers is not transferred to the initiator 1 (step S406: No), the process returns to step S406. After finishing the transmission for the sector of the provided number of transfers to the initiator 1 (step S406: Yes), the exchange executing sections 81 to 8n notify the number of transfer sectors to the transfer management section 350. The transfer management section 350 adds the number of completed number of transfer sectors to the number of sectors transferred up to now in the transfer management table 351 (step S407).

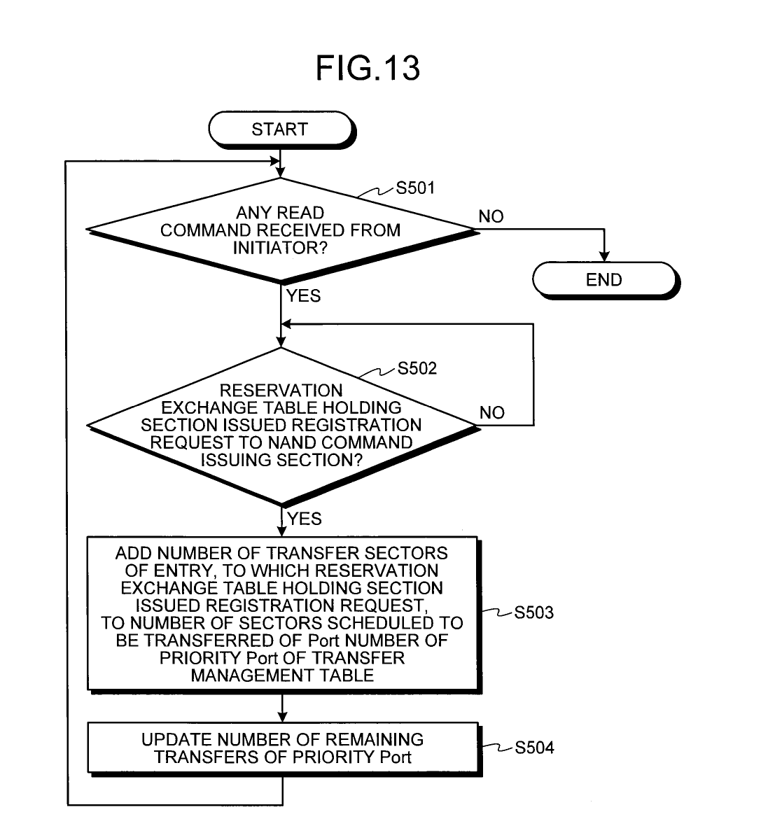

FIG. 13 is a flowchart illustrating the operation of the storage device 300 from the registration of entries to the reservation exchange table 50 to the registration of number of sectors scheduled to be transferred to the transfer management table 351. In step S501, whether or not there is a read command received from the initiator 1 is determined by the firmware 20. If there is not a received read command (step S501: No), the process is terminated. If there is a read command received from the initiator 1 (step S501: Yes), the firmware 20 registers the read command as an entry in the reservation exchange table 50, and the process proceeds to step S502.

In step S502, whether or not the reservation table holding section 5 issued a registration request to the NAND command issuing section 6 is determined based on the entry of the reservation exchange table 50. If the registration request is not issued (step S502: No), the process returns to step S502. If the reservation exchange table holding section 5 issued the registration request to the NAND command issuing section 6 (step S502: Yes), the number of transfer sectors of the entry registration requested by the reservation exchange table holding section 5 is added to the number of sectors scheduled to be transferred corresponding to the Port number of the priority port of the transfer management table 351 (step S503). The priority port, which is the port to be added with the number of transfer sectors of the transfer management table 351 in step S503, is the Port having the least number of remaining transfers selected by the comparator 210 of the transfer management section 350. After step S503, the number of remaining transfers of the priority Port is updated (step S504).

In the third embodiment, the priority Port to be notified to the NAND flash memory control section 7 is determined according to the transfer situation to the initiator 1. In other words, the priority Port that transmits the readout data with respect to the read command is determined regardless of whether or not the port that received the read command. Thus, the port for data transfer can be selected according to the transfer situation to the initiator, the bias of transfer amount for each port can be prevented, and the transfer efficiency can be enhanced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device: comprising
non-volatile memory;
a memory control section;
a table holding section configured to manage a table holding an identifier, with which a read command is identifiable, a logical address of readout data corresponding to the identifier, and readout data length corresponding to the identifier based on the read command;
a read issuing section configured to issue the logical address and the data length for each identifier to the memory control section;
a read buffer configured to hold data received from the non-volatile memory based on a physical address corresponding to the logical address and the data length for each identifier instructed from the memory control section along with the identifier;
an identifier queue configured to receive the identifier of a number proportional to a data length of the data when the data of the logical address is received for the same identifier in the read buffer; and
a transfer section configured to transfer the data corresponding to the identifier received in the read buffer to outside when the identifier is held as incomplete readout in the table in order from the identifier at a head of the identifier queue.

2. The storage device according to claim 1, wherein when an identifier different from a transfer identifier, which is an identifier corresponding to the data transferred to outside, exists at a head of the identifier queue, the table holding section rewrites the logical address and the data length corresponding to the transfer identifier held by the table.

3. The storage device according to claim 2, wherein the table holding section rewrites the logical address corresponding to the transfer identifier to a logical address at a head of a non-transferred readout data, and rewrites the data length corresponding to the transfer identifier to a data length of the non-transferred readout data.

4. The storage device according to claim 1, wherein the table holds a flag indicating whether or not corresponding readout is completed for each identifier.

5. The storage device according to claim 4, wherein when the identifier is held as incomplete readout in the table, the flag corresponding to the identifier indicates incomplete readout.

6. The storage device according to claim 1, wherein the table holding section deletes the identifier and the data corresponding to the identifier from the table when a transfer of the readout data corresponding to the identifier to the initiator is completed.

7. The storage device according to claim 1, wherein the table further holds command information capable of identifying a read command from a plurality of initiators for each identifier.

8. The storage device according to claim 1, wherein the number proportional to the data length of the data is a number of clusters.

9. A storage device comprising:
a plurality of ports connectable to an initiator;
nonvolatile memory;
a memory control section;
a table holding section configured to manage a table in which an identifier, with which a read command is identifiable, a logical address of readout data corresponding to the identifier, and number of data transfers indicating readout data length corresponding to the identifier are registered as an entry based on the read command from the initiator;
a read issuing section configured to issue the logical address and the readout data length for each identifier to the memory control section;
a read buffer configured to hold data read out by the memory control section from the non-volatile memory based on a physical address corresponding to the logical address and the readout data length for each identifier along with the identifier; and
a transfer management section configured to manage number of data scheduled to be transferred and number of data transferred up to now for each port, output a priority port, which is a port with a least number of remaining transfers obtained by subtracting the number of data transferred up to now from the number of data scheduled to be transferred, add the number of data transfers of the entry to the number of data scheduled to be transferred of the priority port when the entry is registered in the table holding section, and add a number corresponding to the readout data to the number of data transferred up to now of the priority port when the readout data is transmitted to the initiator through the priority port.

10. The storage device according to claim 9, further comprising:
a read buffer control section configured to control the read buffer;
a plurality of command requesting sections corresponding to each port; and
a plurality of data frame generating sections corresponding to each port; wherein
the read issuing section receives the priority port output by the transfer management section, and notifies the priority port to the memory control section along with the identifier,
the memory control section holds the data read out from the nonvolatile memory in correspondence with the identifier in the read buffer, and notifies the identifier and the priority port corresponding to the identifier to the read buffer control section,
the read buffer control section registers the identifier corresponding to the priority port in the command requesting section corresponding to the notified priority port, and
the data frame generating section transfers the readout data corresponding to the identifier registered in the command requesting section to the initiator.

11. The storage device according to claim 10, further comprising:
a plurality of exchange executing sections provided for each port in correspondence with each command requesting section; and
a plurality of data frame generating sections provided for each port in correspondence with each command requesting section; wherein
the data frame generating section transfers the readout data corresponding to the identifier registered in the corresponding command requesting section to the initiator through the corresponding port, and
the exchange executing section adds the number of data transfers corresponding to the identifier to the number of data transferred up to now of the corresponding port of the transfer management section after the transfer to the initiator is completed.

12. The storage device according to claim 9, wherein the number of data transfers indicating the readout data length is number of clusters.

13. A read command executing method of a storage device including non-volatile memory and a memory control section; the method comprising:
holding an identifier, with which a read command is identifiable, a logical address of readout data corresponding to the identifier, and readout data length corresponding to the identifier in a table based on the read command;
reading out data to a read buffer from a physical address of the non-volatile memory corresponding to the logical address for each identifier; and
transferring data corresponding to the identifier received by the read buffer to outside when the data of the logical address is received for the same identifier in the read buffer and the identifier is held as incomplete readout in the table.

14. The read command executing method according to claim 13, further comprising rewriting the logical address and the data length corresponding to a transfer identifier held by the table when an identifier different from the transfer identifier, which is an identifier corresponding to the data transferred to outside, exists at a head of a identifier queue.

15. The read command executing method according to claim 14, wherein the rewriting includes rewriting the logical address corresponding to the transfer identifier to a logical address at a head of a non-transferred readout data, and rewriting the data length corresponding to the transfer identifier to a data length of the non-transferred readout data.

16. The read command executing method according to claim 13, wherein the table holds a flag indicating whether or not corresponding readout is completed for each identifier.

17. The read command executing method according to claim 16, wherein when the identifier is held as incomplete readout in the table, the flag corresponding to the identifier indicates incomplete readout.

18. The read command executing method according to claim 13, further comprising deleting the identifier and the data corresponding to the identifier from the table when a transfer of the readout data corresponding to the identifier to the initiator is completed.

19. The read command executing method according to claim 13, wherein the table further folds command information, with which the read command from a plurality of initiators is identifiable, for each identifier.

20. The read command executing method according to claim 13, wherein a number proportional to a data length of the data is number of clusters.
